(19) United States
(12) Patent Application Publication
(10) Pub. No.: US 2006/0210125 A1
(43) Pub. Date: Sep. 21, 2006

(54) Face matching for dating and matchmaking services

(76) Inventor: Bernd Heisele, Cambridge, MA (US)

Correspondence Address: Bernd Heisele, MIT, Bldg. 46-5169, 43 Vassar St., Cambridge, MA, 02139, US

(21) Appl. No.: 11/376,895

(22) Filed: Mar. 16, 2006

Related U.S. Application Data
(60) Provisional application No. 60/663,471, filed on Mar. 21, 2005.

(51) Int. Cl. G05B 19/00; G06K 9/00; H04K 1/00

(52) U.S. Cl. 382/118; 340/5.52; 340/5.53; 713/186

(57) ABSTRACT

A method is disclosed which matches a description of a face with face images in a database. A service/system for dating/matchmaking is disclosed in which a partner profiles comprises a description of a face and a member profile comprises one or multiple image/s of a face. The matching between partner and member profiles comprises a method which matches the description of a face in the partner profile with the face images in the member profiles.

### FIELD OF THE INVENTION

The invention relates to face matching applied to dating/matchmaking services.

### BACKGROUND OF THE INVENTION

Current online dating/matchmaking services ask the customer to submit his/her member profile, referred to as member profile, and the profile of the person they would like to meet, referred to as partner profile. Both, the member and the partner profile usually contain a multitude of textual and numerical information which describe a person's appearance and a person's psycho-social attributes. Once a customer has submitted his/her member and partner profiles, the dating service matches these two profiles with the profiles of other customers to find matching pairs of customers.

The appearance of a person, and especially the face of a person, are important factors in the choice of a partner. However, a textual description of a face, as it is common in partner and member profiles of current dating/matchmaking services, is tedious to generate and often vague.

What is therefore needed are dating/matchmaking services which provide the capability of accurately describing a face and provide methods for matching those descriptions.

### SUMMARY OF THE INVENTION

This invention describes a method for matching a description of a face with face images in a database and the application of this method to dating/matchmaking services.

### BRIEF DESCRIPTION OF THE DRAWINGS

FIG. 1 shows a system for face matching, configured in accordance with one embodiment of the present invention.

FIG. 2 shows a method for aligning faces, configured in accordance with one embodiment of the present invention.

FIG. 3 shows a method for matching aligned faces, configured in accordance with one embodiment of the present invention.

FIG. 4 shows a system for matching profiles, configured in accordance with one embodiment of the present invention.

### DETAILED DESCRIPTION OF THE INVENTION

The invention consists of two parts, the method for face matching and the application of this method to dating/matchmaking services.

Method for Face Matching

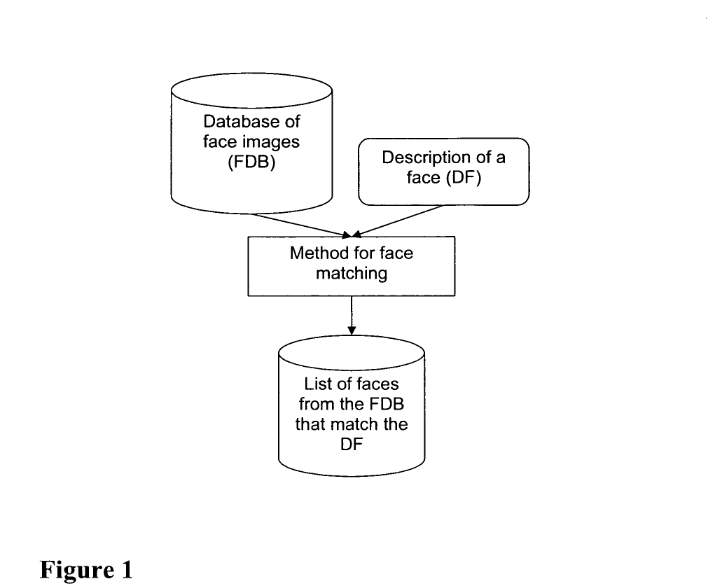

The method for face matching takes a description of a face, referred to as DF, and a database of digital face images, referred to as FDB, as input and returns face images from FDB which match the DF. This is illustrated in FIG. 1.

The following describes one embodiment of the method for matching a DF with face images in FDB. The method described in paragraphs 13 to 15 is applied in the same way to each image in FDB. For ease of understanding, the method is explained for one exemplary image of FDB, referred to as I_db.

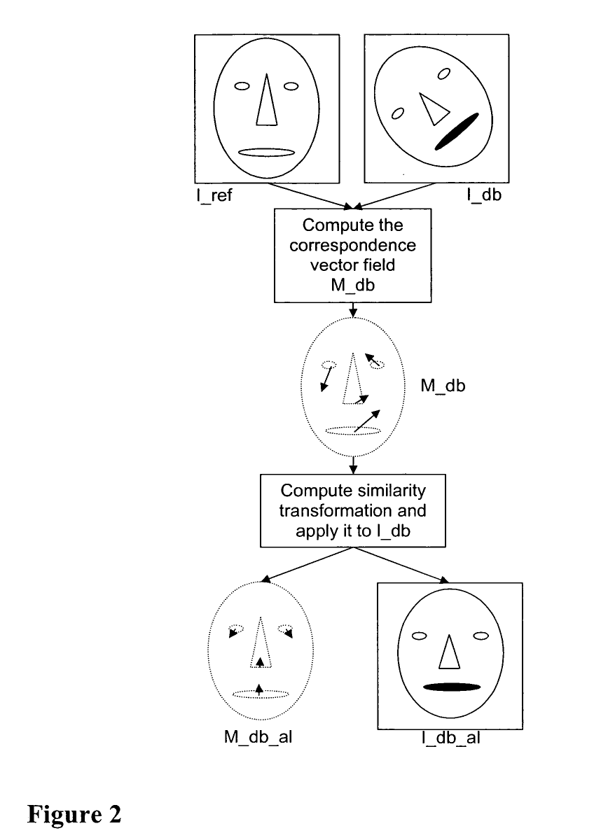

I_db is aligned with a reference face image, referred to as I_ref. The alignment method is illustrated in FIG. 2. I_ref can be any image of a face, it can, but does not have to be, part of FDB. Preferably I_ref is an image of a face with average facial features in frontal pose with neutral facial expression. A correspondence vector field M_db is computed between I_ref and I_db. M_db has the same size as I_ref, each element of M_db is a two dimensional vector. For the purpose of illustration only 4 vectors of M_db are drawn in FIG. 2. To illustrate the locations of the vectors with respect to the parts of the face, I_ref has been overlaid on M_db in FIG. 2. A vector (d_x, d_y) at location (x, y) in M_db indicates that the pixel at location (x, y) in I_ref corresponds to the pixel (x+d_x, y+d_y) in I_db. The method computes the correspondence vector field using a standard computer vision method for the computation of optical flow fields between pairs of images.

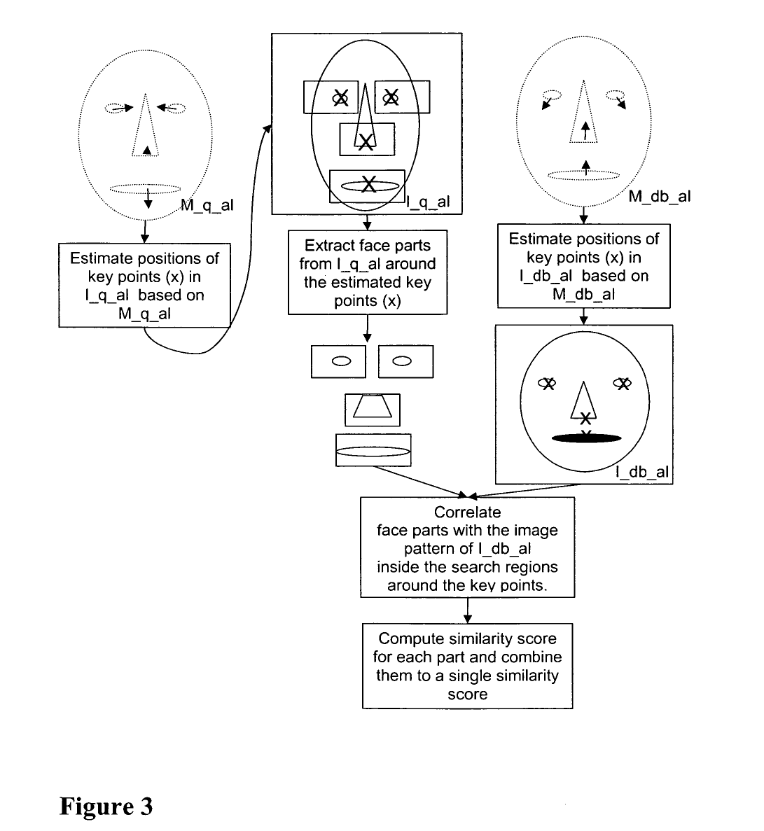

The method applies a similarity transformation (isotropic scaling, translation and rotation) to I_db such that the transformed image, referred to as I_db_al, becomes aligned with I_ref (see FIG. 3). The method determines the parameters of the similarity transformation such that the norm of the residual correspondence vector field, referred to as M_db_al, between I_ref and I_db_al is minimized. The original image I_db is replaced by I_db_al and its correspondence vector field M_db is replaced by M_db_al.

A set of key points is selected in I_ref once. The set of key points can be any set of points in I_ref. The set can be either chosen manually or it can be computed by computer vision methods which locate points of interest in images. An example of such a computer vision method is the Harris corner detector. An exemplary set of key points is shown in FIG. 3, an ‘x’ marks the location of a key point. The positions of the key points are estimated in I_db_al through the correspondence vector field M_db_al.

Paragraphs 17 to 20 describe different embodiments of the matching method for different DFs. The matching method is applied in the same way to each image in FDB. It computes a similarity score for each image in FDB. For ease of explanation, the matching method is explained for one exemplary image of FDB, this image is referred to as I_db. After the computation of the similarity scores has been completed for all images in FDB, the similarity scores are ranked and the images from FDB with the highest similarity scores are returned as the final result of matching.

In one embodiment of the present invention the DF is a single image of a face, referred to as I_q. The matching method finds face images in FDB which are similar to I_q. The remainder of this paragraph describes one embodiment of this matching method. I_q is processed in the same way as I_db (described in paragraphs 13 to 15) resulting in the aligned image I_q_al and the correspondence vector field M_q_al. A set of face parts is extracted from I_q_al around the locations of the estimated key points. The set of face parts can be any set of face parts. An example of such a set consisting of four parts (two eye parts, nose part and mouth part) is illustrated in FIG. 3. Each part is correlated with the image pattern of I_db_al in a search region around the estimated position of its corresponding key point. For example, the right eye part extracted from I_q_al is correlated with the image pattern of I_db_al in a search region around the estimated position of the right eye key point in I_db_al. The similarity score is computed for each part as a function of the correlation values computed inside the search region. In one embodiment of the invention the output of this function is the maximum correlation value. The method computes the overall similarity score between I_q_al and I_db_al as a function of the similarity scores of the parts. In one embodiment of the invention the output of this function is the maximum score.

In one embodiment of the present invention, the DF is a set of already extracted parts of faces, for example the eyes and the nose parts from a face image of person A and the mouth part from a face image of person B. The matching of the face parts with I_db_al is accomplished as described in the previous paragraph.

In another embodiment of the invention the DF is a set of N (N>1) face images which can, but do not necessarily have to be, images of different people. The remainder of this paragraph describes one embodiment of the method for matching a DF consisting of N face images with the images in FDB. Each image in the DF is matched with I_db_al to produce a set of N similarity scores according to paragraph 17. The method computes the final similarity score for I_db_al as a function of the N similarity scores. In one embodiment of the invention the output of this function is the maximum score.

In another embodiment of the invention the DF is a non-pictorial description of a face. A non-pictorial DF can be a textual description of a set of characteristics of a face, for example: “round face, wide-set eyes, large eyes, high cheekbones”. The remainder of this paragraph describes one embodiment of the method for matching a non-pictorial DF with the images in FDB. Based on the estimated locations of the key points in I_db_al, geometrical features are computed from I_db_al which can be compared to the DF. Examples of geometrical features which can be compared to the DF example above are: the roundness of the face, the distance between the eyes, the size of the eyes, the location of the cheekbones within the face. The geometrical features of I_db_al are matched against the DF and a similarity score is computed.

Application of the Method for Face Matching to Dating/Matchmaking Services

The second part of the invention describes the application of face matching to a dating/matchmaking service.

Each subscriber of the dating/matchmaking service can submit one or several digital face picture/s of him/herself, referred to as member picture/s, as part of his/her member profile.

The subscriber can also submit a description of his/her partner's face, referred to as DPF. The DPF is part of the subscriber's partner profile.

In one embodiment of the invention, the member selects one or more face image/s from a database of face images provided by the service. The selected face images represent the DPF of the partner profile.

In one embodiment of the invention, the member selects images of parts face parts from a database of images of face parts provided by the service. The selected images of face parts represent the DPF of the partner profile.

In another embodiment of the invention, the member creates one or more face image/s using a program for generating synthetic images. The created face images represent the DPF of the partner profile.

In another embodiment of the invention, the member creates a non-pictorial DPF, see paragraph 20.

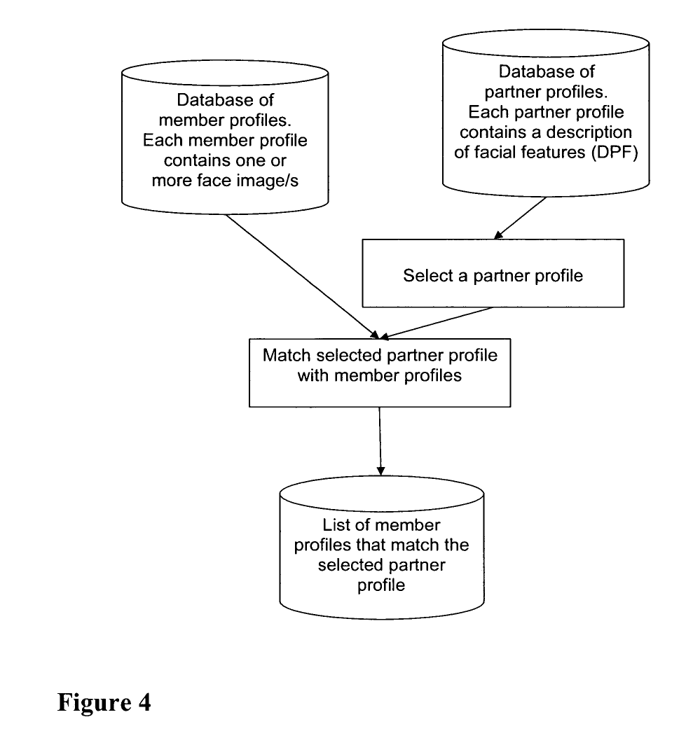

The profile matching method is key to the dating/matchmaking service, it determines finds matches between partner profiles and member profiles, see FIG. 4. In one embodiment of the profile matching method, a partner profile is selected at each step and a list of member profiles that match the selected partner profile is generated. By sequentially iterating through the database of partner profiles, each partner profile will be matched with the member profiles. In the present invention, the face matching method described in the first part (paragraphs 11 to 20) is part of the profile matching method. For a given DPF, the face matching method computes a face similarity score for each member profile based on the member image. If a member profile contains more than one face image, the face matching method computes a separate score for each of image and a combined face similarity score is computed as a function of the separate face similarity scores. In one embodiment the output of this function is the maximum score. The face similarity score for a given member profile is combined with other matching scores found in current dating/matchmaking services to determine how well a given member profile matches the partner profile. An overall score is computed for each member profile and the member profiles with the highest scores are returned as the result of the matching method.

What is claimed is:

1. A system comprising:
a) a database of face images and
b) a description of a face and
c) a matching method which finds faces in database a) that match the description in b).

2. The system according to claim 1 wherein the description of a face in 1 b) is a set of one or multiple face image/s and/or one or multiple image/s of face parts.

3. The system according to claim 1 wherein the description of a face in 1 b) is a non-pictorial description of a face.

4. The system according to claim 1 wherein the matching method in 1 c) computes a measure of the similarity between the description of a face in 1 b) and each face image from the database of face images in 1 a).

5. A system/service for dating/matchmaking comprising:
a) a database of member profiles and
b) a database of partner profiles and
c) a matching method which matches member profiles from database a) with partner profiles from database b).

6. A system according to claim 5 wherein
each member profile in the member database in 5 a) contains one or multiple image/s of faces and
each partner profile in 5 b) contains a description of a face.

7. A system according to claim 6 wherein the description of a face in a partner profile comprises a set of one or multiple face image/s and/or one or multiple image/s of face parts.

8. A system according to claim 6 wherein the description of a face is a non-pictorial description of a face.

9. A system according to claim 6 wherein the matching method in 6 c) comprises a method for matching the description of a face in a partner profile with the face images in the database of member profiles.
